(19) United States
(12) Patent Application Publication
(10) Pub. No.: US 2016/0002505 A1
(43) Pub. Date: Jan. 7, 2016

(54) PRESSURE SENSITIVE ADHESIVE AND IMAGE DISPLAY DEVICE USING THE SAME

(71) Applicant: NITTO DENKO CORPORATION, Ibaraki-shi, Osaka (JP)

(72) Inventors: Masaki MIZUTANI, Ibaraki-shi, Osaka (JP); Yuki HASEGAWA, Ibaraki-shi, Osaka (JP); Yusuke MOTEGI, Ibaraki-shi, Osaka (JP); Shou TAKARADA, Ibaraki-shi, Osaka (JP); Shinya YAMAMOTO, Ibaraki-shi, Osaka (JP); Takami HIKITA, Ibaraki-shi, Osaka (JP)

(73) Assignee: NITTO DENKO CORPORATION, Ibaraki-shi, Osaka (JP)

(21) Appl. No.: 14/771,524

(22) PCT Filed: Mar. 12, 2014
(86) PCT No.: PCT/JP2014/056462

§ 371 Date: Aug. 31, 2015

(30) Foreign Application Priority Data
Mar. 29, 2013 (JP) 2013-075184

(51) Int. Cl. C09J 133/14; G06F 3/041; C09J 165/00

(52) U.S. Cl. CPC C09J 133/14; C09J 165/00; G06F 3/0414

(57) ABSTRACT

The pressure sensitive adhesive of the present invention includes an acryl-based base polymer and a hydrogenated terpene phenolic resin having a softening point of 70° C. to 150° C. The hydrogenated terpene phenolic resin preferably has a terpene molar ratio of 0.1 to 0.7. The content of acryl-based base polymer is preferably 45 to 95 parts by weight based on total 100 parts by weight of the pressure sensitive adhesive composition. In addition, total content of the acryl-based base polymer and the hydrogenated terpene phenolic resin is preferably 70 parts by weight or more. The pressure sensitive adhesive of the present invention is hardly clouded even under a high-temperature and high-humidity environment, and has level difference followability, thus can be used by disposing between a front transparent plate and a touch panel, between a front transparent plate and an image display panel or between a touch panel and an image display panel.

### TECHNICAL FIELD

The present invention relates to pressure sensitive adhesive used for formation of an image display device including a transparent plate or a touch panel on the front surface of an image display panel. Further, the present invention relates to a method for producing an image display device using the pressure sensitive adhesive.

### BACKGROUND ART

Liquid crystal displays and organic EL displays are widely used as various kinds of image display devices of mobile phones, car navigation devices, personal computer monitors, televisions and so on. For the purpose of, for example, preventing damage to the image display panel (a liquid crystal panel or an organic EL panel) due to impact from the outer surface, a front transparent plate (also referred to as a “window layer” etc.) such as a transparent resin plate or a glass plate may be provided on a viewing side of an image display panel. In a display device including a touch panel, generally the touch panel is disposed on a viewing side of an image display panel (hereinafter, the front transparent plate and the touch panel may be referred to together as a “front transparent member”).

When a front transparent member such as a front transparent plate or a touch panel is disposed on a viewing side of an image display panel as described above, an air gap structure (hollow structure) with a gap of about 0.5 to 1.5 mm provided between these layers is formed for protecting the panel surface. However, since the refractive index of air in an air gap structure portion is about 1, whereas the refractive index of a plastic material or a glass material that forms a polarizing plate, a front transparent member and the like of an image display panel is about 1.5, reflection and refraction at an interface increase. Therefore, an image display device having an air gap structure has the problem that diffusion/scattering of image light emitted from an image display panel, and reflection of external light such as sunlight easily occur, leading to deterioration of visibility of the image display device.

For solving the above-mentioned problem, an “interlayer filling structure” has been recently proposed in which the air gap structure portion is filled with a transparent optical resin having a refractive index close to that of glass, resin and the like (see, for example, Patent Documents 1 and 2). In the interlayer filling structure, the air gap is filled with an optical resin to decrease a refractive index difference at the interface, and therefore deterioration of visibility due to reflection and scattering is suppressed. The air gap is filled with an optical resin to increase the strength of the whole image display device, and therefore even if a front transparent plate or the like is damaged, scattering of a constituent material thereof, such as glass, is prevented. Further, by using a pressure sensitive adhesive as an optical resin that forms an interlayer filler, an image display panel and a front transparent member can be bonded and firmly fixed together.

The peripheral edge of a surface of a front transparent member on the image display panel side is often subjected to printing for the purpose of decoration and light shielding. When the peripheral edge is subjected to printing, a level difference with a height of about 10 μm to several tens μm is generated at the boundary of the printed portion, and there may be the problem that bubbles are easily generated in the printing level difference portion when a sheet pressure sensitive adhesive is used as an interlayer filler. In view of such a problem, Patent Document 3 proposes a technique in which by setting the elastic modulus of a pressure sensitive adhesive to fall within a specific range so that the pressure sensitive adhesive has fluidity during bonding, thus a level difference followability (level difference absorbency) is imparted to suppress generation of bubbles at the periphery of a printing level difference portion.

### PRIOR ART DOCUMENTS

### Patent Documents

Patent Document 1: Japanese Patent Laid-open Publication No. 2009-8851

Patent Document 2: Japanese Patent Laid-open Publication No. 2008-281997

Patent Document 3: Japanese Patent Laid-open Publication No. 2012-87240

### SUMMARY OF THE INVENTION

### Problems to be Solved by the Invention

As proposed in Patent Document 3, improvement of the fluidity of a pressure sensitive adhesive is effective for suppression of bubbles at the periphery of a printing level difference portion. As a common method for improving the fluidity of a pressure sensitive adhesive, for example, the molecular weight or the crosslinking degree of a base polymer that forms the pressure sensitive adhesive is reduced. However, when the molecular weight or the crosslinking degree of a base polymer is reduced, a pressure sensitive adhesive layer tends to be easily transferred, or protruded from the end surface, resulting in deterioration of workability and contamination of the surrounding. That is, in general, when level difference followability is to be improved, the handling characteristics of a pressure sensitive adhesive tend to be deteriorated.

When an image display panel provided with an interlayer filler is exposed to a high-temperature and high-humidity environment for a long period of time, the interlayer filler becomes clouded. Patent Document 3 describes that when a base polymer that forms an interlayer filler (pressure sensitive adhesive) contains a polar group-containing monomer component, the cloudiness can be prevented. However, a base polymer with high polarity has low fluidity, and hence poor level difference followability, and thus easily causes the problem of bubbles. Therefore, it is desired to develop an optical pressure sensitive adhesive which has both level difference followability and handling characteristics and is hardly clouded under a high-temperature and high-humidity environment when used as an interlayer filler.

### Means for Solving the Problems

As a result of conducting studies in view of the above mentioned problems, it has been found that a pressure sensitive adhesive containing a specific polymer and tackifier has good handling characteristics in normal handling, and excellent level difference followability, and is hardly clouded, leading to the present invention.

The present invention relates to a pressure sensitive adhesive that is used for disposing between a front transparent plate and a touch panel, between a front transparent plate and an image display panel or between a touch panel and an image display panel. The pressure sensitive adhesive of the present invention contains an acryl-based base polymer, and a hydrogenated terpene phenolic resin having a softening point of 70° C. to 150° C. The hydrogenated terpene phenolic resin preferably has a terpene molar ratio of 0.1 to 0.7.

The content of the acryl-based base polymer is preferably 45 to 95 parts by weight based on total 100 parts by weight of the pressure sensitive adhesive composition. In addition, total content of the acryl-based base polymer and the hydrogenated terpene phenolic resin is preferably 70 parts by weight or more. The acryl-based base polymer preferably has a polar monomer unit content of 3 to 50% by weight based on the total amount of constituent monomer components.

The invention also relates to an image display device. The image display device of the present invention includes at least one of a touch panel and a front transparent plate on a surface of an image display panel, and further includes a pressure sensitive adhesive layer formed of aforementioned pressure sensitive adhesive between the front transparent plate and the touch panel, between the front transparent plate and the image display panel or between the touch panel and the image display panel.

### Effects of the Invention

The pressure sensitive adhesive of the present invention contains a specific tackifier, and therefore is excellent in handling characteristics, has level difference followability, and is hardly clouded under a high-temperature and high-humidity environment when used as an interlayer filler. Thus, the pressure sensitive adhesive according to the present invention is suitably used for formation of an image display device as an interlayer filler disposed between a front transparent plate and a touch panel, between a front transparent plate and an image display panel or between a touch panel and an image display panel.

### BRIEF DESCRIPTION OF THE DRAWINGS

FIG. 1 is a sectional view schematically showing a configuration example of an image display device having an interlayer filler.

### MODE FOR CARRYING OUT THE INVENTION

The pressure sensitive adhesive of the present invention can be used as an interlayer filler which is disposed between an image display panel and a touch panel, between a touch panel and a front transparent plate, between an image display panel and a front transparent plate, or the like.

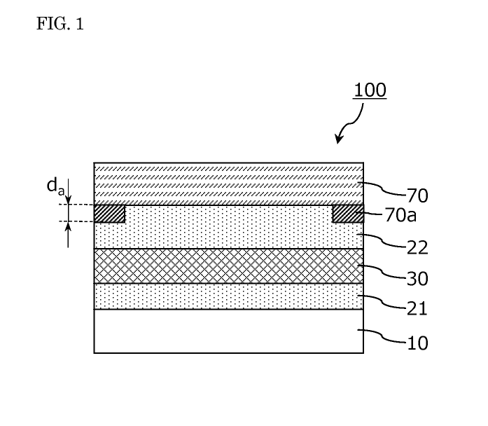

FIG. 1 is a sectional view schematically showing an image display device according to one usage example of the pressure sensitive adhesive of the present invention. The image display device 100 shown in FIG. 1 has a touch panel 30 and a front transparent plate 70 on the surface of an image display panel 10 such as a liquid crystal panel or an organic EL panel. A pressure sensitive adhesive layer 21 between the image display panel 10 and the touch panel 30 and a pressure sensitive adhesive layer 22 between the touch panel 30 and the front transparent plate 70 are each so called an “interlayer filler”, and serve to not only firmly bonding the component members, but also reduce a refractive index difference at the interface to suppress a reduction in visibility due to reflection and scattering of light. The interlayer filler also functions as a cushion layer against an impact and pressing force on the touch panel 30 and the image display panel 10 from the outer surface.

[Composition of Pressure Sensitive Adhesive]

The pressure sensitive adhesive of the present invention contains a base polymer and a tackifier.

As the base polymer, one including an acryl-based polymer as a main component is used. Acryl-based polymers are excellent in optical transparency and adhesiveness and have moderate flexibility. As the acryl-based base polymer, one having a monomer unit of a (meth)acrylic acid alkyl ester as a main skeleton is used. In this specification, the “(math)acryl” means acryl and/or methacryl.

As the (meth)acrylic acid alkyl ester, a (meth)acrylic acid alkyl ester with the alkyl group having 1 to 20 carbon atoms is preferably used. Examples of the (meth)acrylic acid alkyl ester include methyl(meth)acrylate, ethyl(meth)acrylate, butyl(meth)acrylate, isobutyl(meth)acrylate, s-butyl(meth)acrylate, t-butyl(meth)acrylate, pentyl(meth)acrylate, isopentyl(meth)acrylate, neopentyl(meth)acrylate, hexyl(meth)acrylate, heptyl(meth)acrylate, 2-ethylhexyl(meth)acrylate, octyl(meth)acrylate, isooctyl(meth)acrylate, nonyl(meth)acrylate, isononyl(meth)acrylate, decyl(meth)acrylate, isodecyl(meth)acrylate, undecyl(meth)acrylate, dodecyl(meth)acrylate, isotridodecyl(meth)acrylate, tetradecyl(meth)acrylate, isotetradecyl(meth)acrylate, pentadecyl(meth)acrylate, cetyl(meth)acrylate, heptadecyl(meth)acrylate, octadecyl(meth)acrylate, isooctadecyl(meth)acrylate, nonadecyl(meth)acrylate and alakyl(meth)acrylate.

It is preferred that the acryl-based base polymer contains a (meth)acrylic acid alkyl ester having a branched alkyl group as a monomer unit of the (meth)acrylic acid alkyl ester for the purpose of, for example, improving fluidity of the pressure sensitive adhesive. Among the monomers shown above as an example, 2-ethylhexyl(meth)acrylate, isooctyl(meth)acrylate, isononyl(meth)acrylate, isodecyl(meth)acrylate, isotetradecyl(meth)acrylate, isooctadecyl(meth)acrylate and so on are suitably used as the branched alkyl(meth)acrylic acid ester. Two or more branched alkyl(meth)acrylic acid esters may be used in combination. These branched (meth)acrylic acid alkyl esters may be used in combination with a linear(meth)acrylic acid ester.

The content of the (meth)acrylic acid alkyl ester is preferably 40% by weight or more, more preferably 50% by weight or more, further preferably 60% by weight or more based on the total amount of monomer components that form the base polymer. The content of the branched (meth)acrylic acid alkyl ester is preferably 50% by weight or more, more preferably 60% by weight or more based on the total amount of the (meth)acrylic acid alkyl ester.

Preferably, the acryl-based polymer that forms the base polymer contains, in addition to the above-mentioned (meth)acrylic acid alkyl ester, a monomer unit having high polarity. When the base polymer contains a high-polarity monomer unit, cloudiness of the pressure sensitive adhesive at a high-temperature and high-humidity is suppressed when the pressure sensitive adhesive is used as an interlayer filler. The high-polarity monomer unit is preferably a hydroxy group-containing monomer or a nitrogen-containing monomer.

As the hydroxy group-containing monomer, an alcoholic hydroxy group-containing (meth)acrylic acid ester such as 2-hydroxyethyl(meth)acrylate, 2-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate and (4-hydroxymethylcyclohexyl)-methyl acrylate or the like is preferably used.

Examples of the nitrogen containing monomer include N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxylic acid amides and N-vinylcaprolactam.

The ratio of the high-polarity monomer component in the base polymer is not particularly limited, but it is preferably 3 to 50% by weight, more preferably 5 to 30% by weight based on the total amount of constituent monomer components. When the content of the high-polarity monomer is 3% by weight or more, cloudiness of the pressure sensitive adhesive under a high-temperature and high-humidity environment tends to be suppressed. When the content of the polar monomer is 50% by weight or less, the pressure sensitive adhesive has moderate flexibility, so that level difference followability can be exhibited.

When the base polymer is a copolymer of (meth)acrylic acid alkyl ester and aforementioned high-polarity monomer, the arrangement of constituent monomer units may be random, or blockwise. The base polymer may be a copolymer including plural kinds of (meth)acrylic acid alkyl esters or plural kinds of high-polarity monomers.

The acryl-based polymer can be prepared by polymerizing the above-mentioned monomer components by a known common polymerization method. Examples of the method for polymerization of an acryl-based polymer include solution polymerization methods, emulsion polymerization methods, mass polymerization methods, and polymerization by irradiation of an active energy ray (active energy ray polymerization methods). Solution polymerization methods or active energy ray polymerization methods are preferable from the viewpoint of transparency, water resistance, costs and so on.

In preparation of the acryl-based polymer, a polymerization initiator such as a photopolymerization initiator (photo-initiator) or a thermopolymerization initiator may be used depending on a type of polymerization reaction. Polymerization initiators may be used alone, or in combination of two or more thereof. The used amount of the photopolymerization initiator is not particularly limited, but for example, it is preferably 0.01 to 0.5 parts by weight, more preferably 0.05 to 0.3 parts by weight based on total 100 parts by weight of monomer components that form the acryl-based base polymer.

The molecular weight of the base polymer is appropriately adjusted. For example, the polystyrene-equivalent weight average molecular weight is about 50000 to 2000000, preferably about 70000 to 1800000.

The base polymer in the pressure sensitive adhesive of the present invention may have a crosslinked structure as necessary. The crosslinked structure is formed by, for example, adding a crosslinker after polymerization of the base polymer. As the crosslinker, a common cross linker can be used, such as an isocyanate-based crosslinker, an epoxy-based crosslinker, an oxazoline-based crosslinker, an aziridine-based crosslinker, a carbodiimide-based crosslinker or a metal chelate-based crosslinker.

The content of the crosslinker is normally within 0 to 10 parts by weight, preferably 0 to 5 parts by weight based on 100 parts by weight of the acryl-based base polymer. When the content of the crosslinker is excessively large, the flexibility of the pressure sensitive adhesive may be reduced, leading to a reduction in adherence to an adherend. When a crosslinker is used as a pressure sensitive adhesive composition, it is preferred to pass through a heating step for forming a crosslinked structure. The heating temperature and the heating time are appropriately set according to a type of crosslinker to be used, and crosslinking is normally performed by heating at 20° C. to 160° C. for 1 minute to about 7 days.

A silane coupling agent can also be added in the pressure sensitive adhesive for the purpose of adjusting the adhesive strength. When a silane coupling agent is added to the pressure sensitive adhesive, the added amount thereof is normally about 0.01 to 5.0 parts by weight, preferably 0.03 to 2.0 parts by weight based on 100 parts by weight of the acryl-based base polymer.

Besides the aforementioned acryl-based base polymer, the pressure sensitive adhesive of the present invention may contain a silicone-based polymer, a polyester, a polyurethane, a polyamide, a polyvinyl ether, a vinyl acetate/vinyl chloride copolymer, a modified polyolefin, an epoxy-based polymer, a fluorine-based polymer, or a polymer based on a rubber such as a natural rubber or a synthetic rubber, or the like. The content of the aforementioned acryl-based base polymer is preferably 45% by weight or more, more preferably 50% by weight or more, further preferably 55% by weight or more based on total 100 parts by weight of a pressure sensitive adhesive composition, for imparting required properties for an interlayer filler, e.g., transparency and level difference followability,

The pressure sensitive adhesive of the present invention includes a tackifier, in addition to the aforementioned acryl-based base polymer. As the tackifier, a hydrogenated terpene phenolic resin is used. The softening point of the hydrogenated terpene phenolic resin is preferably 70 to 150° C., more preferably 70 to 140° C. The softening point can be measured in accordance with JIS K 2207 “Ring and Ball Softening Point Method”.

When the hydrogenated terpene phenolic resin as a tackifier has a softening point within the above-mentioned range, an intended temperature dependency can be imparted to the elastic modulus of the pressure sensitive adhesive. That is, at normal temperature, the pressure sensitive adhesive has a high elastic modulus (low fluidity), so that the pressure sensitive adhesive layer is inhibited from being transferred and protruded from the end surface, and under a heating environment where the pressure sensitive adhesive layer as an interlayer filler is bonded to an adherend, the pressure sensitive adhesive has a low elastic modulus (high fluidity), so that level difference followability can be imparted.

The terpene molar ratio of the hydrogenated terpene phenolic resin is preferably 0.1 to 0.7, more preferably 0.2 to 0.6. A hydrogenated terpene phenolic resin with terpene molar ratio of aforementioned range has excellent compatibility with the polar group-containing acryl base polymer. Therefore, by using as a tackifier a hydrogenated terpene phenolic with a specific softening point and a specific range of terpene content, a pressure sensitive adhesive can be obtained which is hardly clouded under a high-temperature and high-humidity environment, and has level difference followability. The hydrogenated terpene phenolic resin is preferably one in which the benzene ring of the phenol moiety is also hydrogenated. When the benzene ring is hydrogenated, the resin becomes more colorless and transparent, and heat resistance tends to be improved. As a commercial product of the hydrogenated terpene phenolic resin, “YS Polyster-NH” (product name) manufactured by Yasuhara Chemical Co., LTD, or the like can be used.

A weight average molecular weight of the hydrogenated terpene phenolic resin is preferably about 200 to 5000, more preferably about 500 to 3000, so that the hydrogenated terpene phenolic resin has a softening point in the above-mentioned range and compatibility with the polar group-containing acryl-based base polymer.

The content of the hydrogenated terpene phenolic resin based on total 100 parts by weight of the pressure sensitive adhesive composition is preferably 5 to 55 parts by weight, more preferably 10 to 50 parts by weight, further preferably 15 to 45 parts by weight. The total content of the acryl-based base polymer and the hydrogenated terpene phenolic resin based on total 100 parts by weight of the pressure sensitive adhesive composition is preferably 70 parts by weight or more, more preferably 80 parts by weight or more, further preferably 85 parts by weight or more. When the total content of the acryl-based base polymer and the hydrogenated terpene phenolic resin is excessively low, adhesive strength and transparency may be reduced.

A tackifier other than the above mentioned hydrogenated terpene phenolic resin can be added in the pressure sensitive adhesive layer as necessary. For example, a terpene-based tackifier, a styrene-based tackifier, a phenol-based tackifier, a rosin-based tackifier, an epoxy-based tackifier, a dicyclopentadiene-based tackifier, a polyamide-based tackifier, a ketone-based tackifier, an elastomer-based tackifier or the like can be used. For securing transparency, it is preferred that these tackifiers used in the pressure sensitive adhesive layer are also hydrogenated ones. As the styrene-based tackifier, one that is partially or fully hydrogenated can also be used.

When the tackifier other than the hydrogenated terpene phenolic resin is contained in the pressure sensitive adhesive, the softening point thereof is preferably 70 to 150° C., more preferably 70 to 140° C. The content of the tackifier other than the hydrogenated terpene phenolic resin is preferably 10 parts by weight or less, more preferably 5 parts by weight or less, further preferably 3 parts by weight or less based on 100 parts by weight of the total solid content of the pressure sensitive adhesive composition, in order to suppress the cloudiness of pressure sensitive adhesive.

It is preferred that the pressure sensitive adhesive of the present invention is a photocurable pressure sensitive adhesive from the viewpoint of controlling timing of curing, reliability of curing and so on. The method of photocuring is preferably a method in which a system containing a photocurable monomer or a photocurable oligomer and a photoradical generator is irradiated with an active ray such as an ultraviolet ray. A system using an ethylenically unsaturated compound and a photoradical generator is preferred because it has a high level of photosensitivity and can be selected from a wide range of materials. The photocurable ethylenically unsaturated compound may be a monofunctional compound, or may be a polyfunctional compound.

The photocurable monomers or oligomers may be used in combination of two or more thereof. For preparing the photocurable pressure sensitive adhesive, the photocurable compound is required to exist as a monomer or an oligomer in the pressure sensitive adhesive composition. Therefore, it is preferred that the photocurable compound is added to the system after polymerization of the base polymer.

When the pressure sensitive adhesive of the present invention is a photocurable pressure sensitive adhesive, the content of the photocurable compound is preferably 2 to 50 parts by weight, more preferably 5 to 30 parts by weight based on 100 parts by weight of the total solid content of the pressure sensitive adhesive composition. When the content of the photocurable compound is excessively large, the fluidity of the pressure sensitive adhesive before curing increases, so that handling characteristics deterioration and contamination may occur.

It is preferred that the photocurable pressure sensitive adhesive contains a photoradical generator in the pressure sensitive adhesive composition. As the photoradical generator, a compound having one or more radical generation points in the molecule is used, and examples thereof include hydroxyketones, benzyl dimethyl ketals, aminoketones, acylphosphine oxides, benzophenones and trichloromethyl-containing triazine derivatives. The photoradical generators may be used alone, or may be used in combination of two or more thereof. A monofunctional type photoradical generator and a polyfunctional type photoradical generator may be used in combination as appropriate. The content of the photoradical generator is preferably 0.01 to 10 parts by weight, more preferably 0.05 to 8 parts by weight based on 100 parts by weight of the total solid content of the pressure sensitive adhesive composition.

[Formation of Pressure Sensitive Adhesive Layer]

As the method for forming the pressure sensitive adhesive layer, various kinds of methods are used. Specific examples include roll coating, kiss roll coating, gravure coating, reverse coating, roll brushing, spray coating, dip roll coating, bar coating, knife coating, air knife coating, curtain coating, lip coating, and extrusion coating methods using a die coater etc. Among them, use of a die coater is preferred, and in particular, use of a die coater using a fountain die or a slot die is more preferred.

As a method for drying the applied pressure sensitive adhesive, a suitable method can be appropriately employed according to a purpose. The heating/drying temperature is preferably 40° C. to 200° C., further preferably 50° C. to 180° C., especially preferably 70° C. to 170° C. Suitable drying time can be appropriately employed. The drying time is preferably 5 seconds to 20 minutes, more preferably 5 seconds to 15 minutes, further preferably 10 seconds to 10 minutes.

[Properties of Pressure Sensitive Adhesive Layer]

The storage elastic modulus G′_{25° C.} of the pressure sensitive adhesive layer at 25° C. is preferably 1.0×10⁴ Pa to 1.0×10⁷ Pa, more preferably 3.0×10⁴ Pa to 7.0×10⁶ Pa, further preferably 5.0×10⁴ Pa to 5.0×10⁶ Pa. When the storage elastic modulus at 25° C. (normal temperature) is excessively small, the pressure sensitive adhesive protrudes from the end surface under pressure at the time of cutting of the pressure sensitive adhesive layer or at the time of bonding, so that defects such as contamination may occur. On the other hand, when the storage elastic modulus at 25° C. is excessively large, cracking and chipping tend to easily occur at the end surface (cut surface) of the pressure sensitive adhesive during or after cutting.

The storage elastic modulus G′_{80° C.} of the pressure sensitive adhesive layer at 80° C. is preferably 1.0×10² Pa to 1.0×10⁵ Pa. G′_{80° C.} of the pressure sensitive adhesive layer is more preferably 5.0×10⁴ Pa or less, further preferably 3.0×10⁴ Pa or less, especially preferably 1.0×10⁴ Pa or less. When G′_{80° C.} falls within the above-mentioned range, the fluidity of the pressure sensitive adhesive layer under a heating environment falls within an appropriate range. Accordingly, even when the adherend (e.g., front transparent plate 70 in FIG. 1) has a level difference such as a printed portion 70a, a protrusion or the like, the shape of the pressure sensitive adhesive layer follows the shape of the level difference, so that ingress of bubbles is suppressed. Even when bonding is performed at normal temperature, bubbles in the vicinity of the level difference, which enter during bonding, can be effectively removed by heating after bonding as long as the storage elastic modulus G′_{80° C.} of the pressure sensitive adhesive layer is 1.0×10⁵ Pa or less.

The storage elastic modulus of the pressure sensitive adhesive layer can be controlled to fall within the above-mentioned range by adjusting the structure and molecular weight of the base polymer, the type and content of the additives, and so on. Particularly, in the present invention, a tackifier consisting of a hydrogenated terpene phenolic resin having a specific softening point is used, and thus the above-mentioned temperature dependency can be imparted to the elastic modulus of the pressure sensitive adhesive layer. Specifically, the elastic modulus of the pressure sensitive adhesive layer is high at 25° C. (normal temperature), because the temperature is not higher than the softening point of the tackifier, and the tackifier is softened when heated, so that the elastic modulus at a high-temperature decreases.

In the present invention, 80° C. storage elastic modulus at the time when the pressure sensitive adhesive layer is bonded to an adherend such as a touch panel or a front transparent plate is preferably smaller than 80° C. storage elastic modulus of the pressure sensitive adhesive layer in a final product after formation of an image display device. For example, in the case where a photocurable or thermosetting pressure sensitive adhesive is used, the pressure sensitive adhesive layer has moderate adhesiveness and fluidity when bonding is performed before the pressure sensitive adhesive is cured. When the pressure sensitive adhesive is cured by application of an active ray or heating at the time of bonding or after a heating treatment is performed in an autoclave, the storage elastic modulus of the pressure sensitive adhesive layer can be increased to suppress defects such as peeling of the pressure sensitive adhesive layer.

Particularly, for achieving both adhesiveness and fluidity at the time of bonding and reliability of adhesion after formation of the image display device, the storage elastic modulus G′_{80° C.} of the pressure sensitive adhesive layer at 80° C. after curing is preferably 1.0×10³ Pa to 1.0×10⁶ Pa, more preferably 3.0×10³ Pa to 7.0×10⁵ Pa, further preferably 5.0×10³ Pa to 5.0×10⁵ Pa. For achieving both adhesiveness and fluidity at the time of bonding and adhesion reliability after formation of the image display device, the ratio of the storage elastic modulus G′_{80° C.} of the pressure sensitive adhesive layer after curing to the storage elastic modulus G′_{80° C.} of the pressure sensitive adhesive layer before curing is preferably 2 or more, more preferably 3 or more, further preferably 5 or more.

[Usage of Pressure Sensitive Adhesive]

As mentioned above, the pressure sensitive adhesive of the present invention is preferably used as an interlayer filler which is disposed between an image display panel and a touch panel, between a touch panel and a front transparent plate, between an image display panel and a front transparent plate, or the like. It is preferred that a protective sheet is releasably attached on the pressure sensitive adhesive layer for protecting the exposed surfaces of the pressure sensitive adhesive layer, as necessary, until the pressure sensitive adhesive layer is put into practical use. Examples of the constituent material of each of the protective sheet include plastic films such as polyethylene, polypropylene, polyethylene terephthalate and polyester films, porous materials such as paper, cloth and nonwoven fabrics, and appropriate thin foliated materials such as nets, foamed sheets, metal foils and laminates thereof. Among them, plastic films are suitably used because they are excellent in surface smoothness.

The pressure sensitive adhesive layer provided with the protective sheet is cut to a desired size as necessary, and put into practical use. Generally, a long-shaped sheet pressure sensitive adhesive layer provided with the protective sheet is cut to a product size consistent with a size (screen size) of an image display device. Examples of the cutting method include a method of punching the film using a Thompson blade etc., a method using a cutter with a circular shear, a plate blade or the like, laser light or hydraulic pressure.

In formation of an image display device, the procedure, method and the like, for bonding the pressure sensitive adhesive layer is not particularly limited. In bonding of the pressure sensitive adhesive layer to a component member having a non-flat portion such as the printed portion 70a in the front transparent plate 70 as shown in FIG. 1, it is preferable to perform degassing for removing bubbles in the vicinity of the non-flat portion such as the printed portion 70a. As a degassing method, an appropriate method such as heating, pressurization or pressure reduction can be employed. For example, it is preferred that bonding is performed while ingress of bubbles is suppressed under reduced pressure and heating, and pressurization is then performed in parallel with heating through autoclave or the like for the purpose of, for example, suppressing delay bubbles. When degassing is performed by heating, the heating temperature is in a range of generally about 30° C. to 150° C., preferably 40° C. to 130° C., more preferably 50° C. to 120° C., further preferably 60° C. to 100° C. When pressurization is performed, the pressure is in a range of generally about 0.05 MPa to 2 MPa, preferably 0.1 MPa to 1.5 MPa, more preferably 0.2 MPa to 1 MPa.

### EXAMPLES

The present invention will be described more specifically below by showing examples and comparative examples, but the present invention is not limited to these Examples.

### Synthesis Example

### Synthesis Example 1

75 parts by weight of 2-ethylhexyl acrylate (2EHA), 25 parts by weight of N-vinylpyrrolidone (NVP), 0.2 parts by weight of azobisisobutyronitrile (AIBN) as a polymerization initiator and 233 parts by weight of ethyl acetate were introduced into a separable flask provided with a thermometer, a stirrer, a reflux cooling tube and a nitrogen gas inlet, and a nitrogen gas was then fed to perform nitrogen purge for 1 hour while the mixture was stirred. Thereafter, the flask was heated to 70° C., the mixture was reacted for 5 hours to obtain an acryl-based polymer having a weight average molecular weight (Mw) of 800000 (hereinafter, this base polymer is referred to as a “polymer 1”).

### Synthesis Example 2

65 parts by weight of 2EHA, 10 parts by weight of methyl methacrylate (MMA), 15 parts by weight of NVP, 10 parts by weight of hydroxyethyl acrylate (HEA), 0.2 parts by weight of AIBN as a polymerization initiator and 233 parts by weight of ethyl acetate were introduced into a separable flask provided with a thermometer, a stirrer, a reflux cooling tube and a nitrogen gas inlet, and a nitrogen gas was then fed to perform nitrogen purge for 1 hour while the mixture was stirred. Thereafter, the flask was heated to 70° C., the mixture was reacted for 5 hours to obtain an acryl-based polymer having a weight average molecular weight (Mw) of 800000 (hereinafter, this base polymer is referred to as a “polymer 2”).

### Examples 1 and 2 and Comparative Examples 1 to 5

The polymer 1 or 2 was used as a base polymer, and compounds as shown in Table 1 were mixed and dissolved to prepare a pressure sensitive adhesive composition (the numbers in the pressure sensitive adhesive composition in Table 1 are all in parts by weight). The prepared pressure sensitive adhesive composition was applied onto a PET separator to have a thickness after drying would be 100 μm, and the applied solution was dried to obtain a pressure sensitive adhesive layer.

In Table 1, the tackifier 1 (YS Polyster-NH) is a hydrogenated terpene phenolic resin manufactured by Yasuhara Chemical Co., LTD, and has a softening point of 130° C. and a terpene ratio of 0.5 mol. The tackifier 2 (YS Polyster-UH) is a hydrogenated terpene phenolic resin manufactured by Yasuhara Chemical Co., LTD, and has a softening point of 115° C. and a terpene ratio of 0.8 mol. The tackifier 3 (YS Resin SX100) is a styrene oligomer manufactured by Yasuhara Chemical Co., Ltd, and has a softening point of 100° C. The tackifier 4 (Pinecrystal KE-311) is a hydrogenated rosin ester manufactured by Arakawa Chemical Industries, Ltd., and has a softening point of 95° C. The photocurable compound (NK Ester APG-400) was a polyethylene glycol diacrylate (difunctional acrylate) manufactured by SHIN-NAKAMURA CHEMICAL CO., LTD. The polymerization initiator (IRGACURE 184) is an alkylphenone-based photopolymerization initiator manufactured by Ciba Specialty Chemicals Corporation).

### Evaluation

### Preparation of Pseudo Image Display Device for Evaluation

The pressure sensitive adhesive layer obtained in each of Examples and Comparative Examples was bonded to a flat glass plate (0.7 mm×50 mm×100 mm), and the PET separator was then peeled off. A glass plate with a frame-like shaped black ink printing portion (thickness: 20 μm) on the periphery edge (0.7 mm×50 mm×100 mm; ink printing width: 10 mm from the edge) was placed on an exposed surface of the pressure sensitive adhesive after the separator was peeled off in a manner that the printed surface and the pressure sensitive adhesive layer were in contact with each other, and then bonding was performed by thermocompression using a vacuum thermocompression device (temperature: 80° C.; pressure: 0.3 MPa; pressure retention time: 5 seconds). Thereafter, an autoclave treatment was performed (50° C., 0.5 MPa, 30 minutes). Only in Example 2, an ultraviolet ray was applied from the glass plate side using a metal halide lamp (300 mW/cm²) after the autoclave treatment, so that the photocurable pressure sensitive adhesive was cured (integrated light amount: 3000 mJ/cm²). Pseudo image display device for evaluation was thus obtained.

<Evaluation of Bubbles>

The vicinity of the inside of a black ink-printed portion in the pseudo image display device for evaluation was observed with a digital microscope at a magnification of 20 to check whether or not bubbles exist in the pressure sensitive adhesive layer (initial evaluation). In addition, after the pseudo image display device for evaluation was placed in an oven at 85° C. for 48 hours, presence/absence of bubbles was checked using a same method.

<Cloudiness>

Visual inspection was performed to check whether or not the pressure sensitive adhesive layer in the sample (pseudo image display device for evaluation) was clouded (initial evaluation). The sample was then placed into a thermohygrostat bath at 60° C. and 95% RH for 240 hours. Thereafter, the sample was taken out, and stored under an environment at 25° C. and 50% RH for 24 hours, followed by visual inspection for checking whether or not the pressure sensitive adhesive layer was clouded.

Table 1 shows a list of compositions of the pressure sensitive adhesive layer and evaluation results for each of the Examples and Comparative Examples.

TABLE 1

| | | | | | Compar- | Compar- | Compar- | | |
|---|---|---|---|---|---|---|---|---|---|
| | | | | | ative | ative | ative | Comparative | Comparative |
| | | | Example 1 | Example 2 | Example 1 | Example 2 | Example 3 | Example 4 | Example 5 |
| pressure | polymer 1 | 2EHA/NVP = | 70 | — | 100 | — | 70 | 70 | 70 |
| sensitive | | 75/25 | | | | | | | |
| adhesive | polymer 2 | 2EHA/MMA/NVP/HEA = | — | 70 | — | 100 | — | — | — |
| composition | | 65/10/15/10 | | | | | | | |
| | tackifier 1 | hydrogenated terpene phenol | 30 | 30 | — | — | — | — | — |
| | | YS Polyster-NH | | | | | | | |
| | | (softening point: 130° C.; | | | | | | | |
| | | terpene ratio: 0.5 mol) | | | | | | | |
| | tackifier 2 | hydrogenated terpene phenol | — | — | — | — | 30 | — | — |
| | | YS Polyster-UH | | | | | | | |
| | | (softening point: 115° C.; | | | | | | | |
| | | terpene ratio: 0.8 mol) | | | | | | | |
| | tackifier 3 | styrene oligomer | — | — | — | — | — | 30 | — |
| | | YS Resin SX100 | | | | | | | |
| | | (softening point: 85° C.) | | | | | | | |
| | tackifier 4 | hydrogenated rosin ester | — | — | — | — | — | — | 30 |
| | | Pinecrystal KE-311 | | | | | | | |
| | | (softening point: 95° C.) | | | | | | | |
| | photocurable | polyethylene glycol diacrylate | — | 15 | — | — | — | — | — |
| | compound | NK Ester APG-400 | | | | | | | |
| | polymerization | alkylphenone-based | — | 0.2 | — | — | — | — | — |
| | initiator | photopolymerization initiator | | | | | | | |
| | | IRGACURE 184 | | | | | | | |
| evaluation | bubble | initial | absent | absent | present | present | absent | absent | absent |
| result | | after 85° C. × 48 h | absent | absent | present | present | absent | absent | absent |
| | cloudiness | initial | absent | absent | absent | absent | present | absent | absent |
| | | after 60° C. 95% RH × 240 h | absent | absent | absent | absent | present | present | present |

In each of Examples 1 and 2 where a pressure sensitive adhesive containing the tackifier 1 was used, bubbles were not generated, and cloudiness did not occur after exposure to a high-temperature and high-humidity environment. In Comparative Examples 1 and 2 where a pressure sensitive adhesive which did not contain a tackifier was used, the pressure sensitive adhesive was not clouded, but bubbles were generated in the vicinity of the printed portion (level difference).

On the other hand, in Comparative Examples 3 to 5, bubbles were not generated because a pressure sensitive adhesive containing a tackifier having a softening point within a specific range was used. However, in Comparative Example 3 where the tackifier 2 in which the terpene molar ratio was 0.8 was used, the pressure sensitive adhesive was clouded even before being exposed to a high-temperature and high-humidity environment. This is ascribable to low compatibility between the acryl-based base polymer that forms the pressure sensitive adhesive and the hydrogenated terpene phenol having a high terpene ratio. In Comparative Examples 4 and 5, cloudiness did not occur in the initial stage, but the pressure sensitive adhesive layer after exposure to a high-temperature and high-humidity environment was clouded.

From the above results, it is apparent that only a pressure sensitive adhesive containing a specific tackifier can satisfy both level difference followability and inhibition of cloudiness during exposure to a high-temperature and high-humidity environment when used as an interlayer filler.

### DESCRIPTION OF REFERENCE CHARACTERS

10 image display panel
21, 22 pressure sensitive adhesive layer (interlayer filler)
30: touch panel
70: front transparent member (touch panel or front transparent plate)
100: image display device

1. A pressure sensitive adhesive configured to be disposed between a front transparent plate and a touch panel, between a front transparent plate and an image display panel or between a touch panel and an image display panel, wherein
the pressure sensitive adhesive contains an acryl-based base polymer, and a hydrogenated terpene phenolic resin having a softening point of 70° C. to 150° C.,
the hydrogenated terpene phenolic resin has a terpene molar ratio of 0.1 to 0.7, and
based on total 100 parts by weight of a pressure sensitive adhesive composition, a content of the acryl-based base polymer is 45 to 95 parts by weight, and a total content of the acryl-based base polymer and the hydrogenated terpene phenolic resin is 70 parts by weight or more.

2. The pressure sensitive adhesive according to claim 1, wherein
the acryl-based base polymer has a polar monomer unit content of 3 to 50% by weight based on a total amount of constituent monomer components.

3. An image display device comprising: an image display panel; at least one of a touch panel and a front transparent plate on a surface of the image display panel: and a pressure sensitive adhesive layer formed of the pressure sensitive adhesive between the front transparent plate and the touch panel, between the front transparent plate and the image display panel or between the touch panel and the image display panel, wherein
the pressure sensitive adhesive contains an acryl-based base polymer, and a hydrogenated terpene phenolic resin having a softening point of 70° C. to 150° C.,
the hydrogenated terpene phenolic resin has a terpene molar ratio of 0.1 to 0.7, and
based on total 100 parts by weight of a pressure sensitive adhesive composition, a content of the acryl-based base polymer is 45 to 95 parts by weight, and a total content of the acryl-based base polymer and the hydrogenated terpene phenolic resin is 70 parts by weight or more.

4. The pressure sensitive adhesive according to claim 2, wherein
the polar monomer unit is one or more selected from a group consisting of alcoholic hydroxy group-containing monomers and nitrogen-containing monomers.

5. The pressure sensitive adhesive according to claim 1, further containing a photocurable compound.

6. The pressure sensitive adhesive according to claim 5, wherein
a content of the photocurable compound is 2 to 50 parts by weight based on 100 parts by weight of a total solid content of the pressure sensitive adhesive composition.

7. The image display device according to claim 3, wherein
the acryl-based base polymer has a polar monomer unit content of 3 to 50% by weight based on a total amount of constituent monomer components.

8. The image display device according to claim 7, wherein
the polar monomer unit is one or more selected from a group consisting of alcoholic hydroxy group-containing monomers and nitrogen-containing monomers.
